(19) United States
(12) Patent Application Publication
(10) Pub. No.: US 2021/0255716 A1
(43) Pub. Date: Aug. 19, 2021

(54) INTELLIGENT STYLUS WITH BATTERY LEVEL INDICATOR

(71) Applicant: Shenzhen Jinji Digital Technology Co.,Ltd, Shenzhen (CN)

(72) Inventor: Jiazhe Jin, Shenzhen (CN)

(73) Assignee: Shenzhen Jinji Digital Technology Co.,Ltd

(21) Appl. No.: 17/313,028

(22) Filed: May 6, 2021

(30) Foreign Application Priority Data
Aug. 13, 2020 (CN) 202021682895.9

(51) Int. Cl. G06F 3/0354; G06F 1/26; H02J 7/00

(52) U.S. Cl. CPC G06F 3/03545; H02J 7/0042; H02J 7/0047; G06F 1/26

(57) ABSTRACT

The present disclosure discloses an intelligent stylus with a battery level indicator. The intelligent stylus includes a stylus tail cap, a stylus body and a stylus tip. The stylus body includes an aluminum holder shell and a holder internal component; the stylus tail cap is arranged at the tail portion of the aluminum holder shell; aluminum holder shell is arranged at a large portion of the stylus body; the holder internal component includes a switch charging component, an LED battery level indicator component, internal connection components and a ground clip; the switch charging component is arranged at the front portion of the stylus tail cap; LED battery level indicator component is arranged at the front portion of the switch charging component; internal connection components are arranged on both sides of a battery inside the stylus body; and the stylus tip is arranged at a head portion of the stylus body.

### TECHNICAL FIELD

The present disclosure relates to the technical field of intelligent styluses, and specifically relates to an intelligent stylus with a battery level indicator.

### BACKGROUND

A stylus (or stylus pen) is a small pen-shaped tool used to input an instruction into a device having a touch screen, such as a computer screen, a mobile device and a drawing board, and a user can click the touch screen through the stylus to select a file or a drawing.

In the field of intelligent styluses, a real-time battery level cannot be determined on a stylus body of all styluses. Although, for some capacitive styluses, their battery level can be determined by the color of an indicator, this determination method has the defects of inaccurate determination, high memorization cost and the like; and a sudden power failure would be caused by a mis-judgment on the battery level color, thereby affecting the usage experience.

### SUMMARY

The present disclosure is developed to provide an intelligent stylus with a battery level indicator, and aims to solve the technical problem that the battery level is hard to display during use of a stylus.

In order to achieve the above purpose, the present disclosure provides the following technical solution:

an intelligent stylus with a battery level indicator, including a stylus tail cap, a stylus body and a stylus tip. The stylus body includes an aluminum holder shell and a holder internal component; the stylus tail cap is arranged at the tail portion of the aluminum holder shell; the aluminum holder shell is arranged at a large portion of the stylus body; the holder internal component includes a switch charging component, an LED battery level indicator component, internal connection components and a ground clip; the switch charging component is arranged at the front portion of the stylus tail cap; the LED battery level indicator component is arranged at the front portion of the switch charging component; the internal connection components are arranged on both sides of a battery inside the stylus body; and the stylus tip is arranged at a head portion of the stylus body.

As a further solution of the present disclosure, the stylus tail cap is composed of a screw, a cylindrical magnet with screw hole, a stylus tail cap aluminum piece and a stylus tail cap plastic piece; the screw is in female threaded connection with the stylus tail cap plastic piece through the cylindrical magnet, and passes through the stylus tail cap aluminum piece to form the stylus tail cap.

As a further solution of the present disclosure, the switch charging component is composed of a switch plate plastic positioning piece, a switch and indicator printed circuit board (PCB) and a magnetic attraction iron piece; the switch plate plastic positioning piece is provided with a plastic button hole and a plurality of LED light-transmittance holes, and is aligned with a power button and a charging port on the switch and indicator PCB; a Microusb charging port slot is formed in the magnetic attraction iron piece; and the charging port and the Microusb charging port slot form a charging port.

As a further solution of the present disclosure, the LED battery level indicator component is formed by combining the switch plate plastic positioning piece and the switch and indicator PCB; and switch plate plastic positioning piece is provided with the plurality of LED light-transmittance holes that are adhered to LED light-shield isolation pillars on the switch and indicator PCB.

As a further solution of the present disclosure, the internal connection components are composed of two flexible printed circuit (FPC) flat cable connectors, and magnet and magnet connection components; the two FPC flat cable connectors include an FPC flat cable connector A and an FPC flat cable connector B; and the magnet and magnet connection components include a magnet and magnet connection component A and a magnet and magnet connection component B.

As a further solution of the present disclosure, the ground clip is arranged at the front portion of the FPC flat cable connector B.

As a further solution of the present disclosure, the stylus tip is composed of a plastic stylus tip cap, a stylus needle, an aluminum oxidization tube, a threaded copper piece, an aluminum tube pressing piece and a main PCB.

As a further solution of the present disclosure, the aluminum oxidization tube is a cylindrical hard oxidization piece, the inner and outer walls of which are provided with insulators.

As a further solution of the present disclosure, the plastic stylus tip cap and the threaded copper piece are in threaded connection with each other.

As a further solution of the present disclosure, the ground clip is connected with a metal ground antenna through the main PCB; the head portion of the main PCB is disposed on the aluminum holder shell through a plastic positioning pillar; a magnet A is mounted on a side of the main PCB corresponding to a flat part of the aluminum holder shell through an insulation sheet; and a magnet B is also mounted in a flat groove of a magnetic body plastic positioning piece located inside the aluminum holder shell.

Compared with the prior art, the present disclosure has the beneficial effects:

The intelligent stylus with the battery level indicator is reasonable in structure and novel in design; a plurality of LED indicators are arranged in the stylus, so that the battery level of the stylus can be visibly displayed according to the number of indicators that are turned on, which is simple and identifiable and saves the memorization cost, thereby enhancing the usage experience of a user.

### BRIEF DESCRIPTION OF THE DRAWINGS

FIG. 1 is a schematic diagram of a stereoscopic combined structure of an intelligent stylus with a battery level indicator.

FIG. 2 is a stereoscopically exploded schematic structural diagram of an intelligent stylus with a battery level indicator.

FIG. 3 is an internally sectional schematic structural diagram of an intelligent stylus with a battery level indicator.

FIG. 4 is a schematic structural diagram of a switch plate plastic positioning piece in an intelligent stylus with a battery level indicator.

FIG. 5 is a schematic structural diagram of a switch and indicator printed circuit board (PCB) in an intelligent stylus with a battery level indicator.

In the drawings: 1: aluminum holder shell; 2: plastic stylus tip cap; 3: plastic positioning pillar, 4: metal ground antenna; 5: stylus tip; 6: aluminum oxidization tube; 7: threaded copper piece; 8: aluminum tube pressing piece; 9: main PCB; 10: magnet A; 11: battery, 12: magnetic body plastic positioning piece; 13: magnet B; 14: switch plate plastic positioning piece; 15: switch and indicator PCB; 16: magnetic attraction iron piece; 17: screw; 18: cylindrical magnet; 19: stylus tail cap aluminum piece; 20: stylus tail cap plastic piece; 21: ground clip; 22: two flexible printed circuit (FPC) flat cable connectors; 23: magnet and magnet connection component; 14-1: plastic button hole; 14-2: LED light-transmittance plate; 15-1: power button; 15-2: charging port; 15-3: LED light-shield isolation pillar; 16-1: charging port slot; 22-1: FPC flat cable connector A; 22-2: FPC flat cable connector B; 23-1: magnet and magnet connection component A; and 23-2: magnet and magnet connection component B.

### DESCRIPTION OF THE EMBODIMENTS

It should be noted that the embodiments in the present disclosure and features in the embodiments may be combined with each other without conflicts.

In the description of the present disclosure, it should be understood that orientations or positional relationships indicated by the terms “center”, “longitudinal”, “transverse”, “upper”, “lower”, “front”, “rear”, “left”, “right”, “vertical”, “horizontal”, “top”, “bottom”, “inside”, “outside” and the like are orientations or positional relationships as shown in the drawings, and are only for the purpose of facilitating and simplifying the description of the present disclosure instead of indicating or implying that devices or elements indicated must have particular orientations, and be constructed and operated in the particular orientations, so that these terms are not construed as limiting the present disclosure. In addition, the terms “first”, “second” and the like are only for the purpose of description, and may not be understood as indicating or implying the relative importance or impliedly indicating the number of technical features indicated. Therefore, features defined by “first”, “second” and the like can explicitly instruct or impliedly include one or more features. In the description of the present disclosure, unless otherwise indicated, “plurality” means two or more.

In the description of the present disclosure, it should be noted that unless otherwise explicitly defined and defined, the terms “installed”, “coupled” and “connected” shall be understood broadly, and may be, for example, fixedly connected, or detachably connected, or integrally connected, or mechanically connected, or electrically connected, or directly connected, or indirectly connected through an intermediate medium, or interconnection between two elements. Those of ordinary skill in the art can understand the specific meanings of the above terms in the present disclosure according to specific situations.

The present disclosure will be described in detail below with reference to the accompanying drawings and in combination with embodiments.

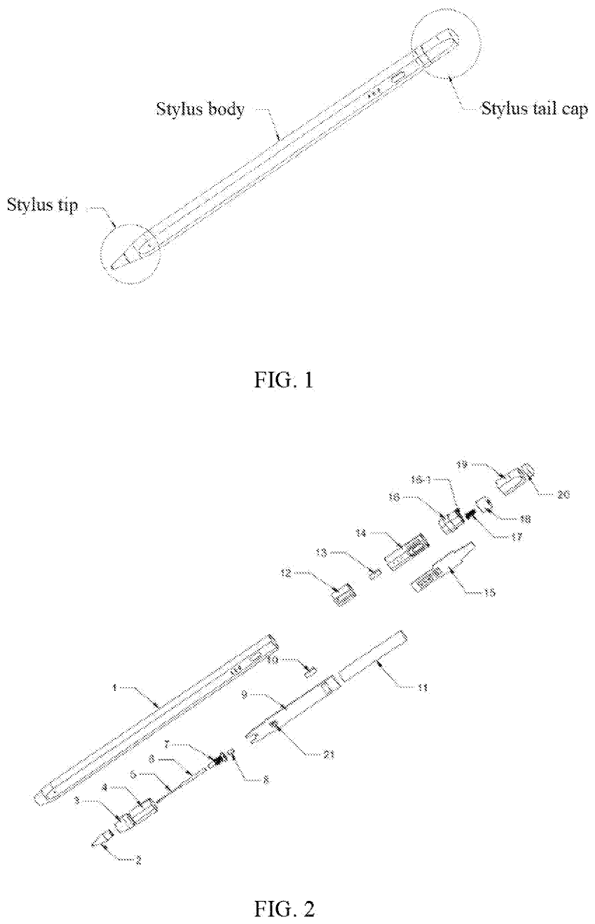

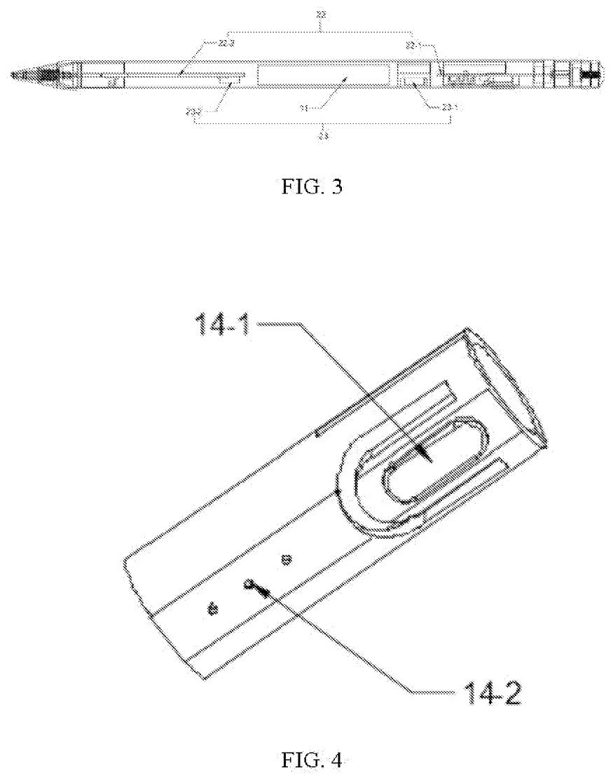

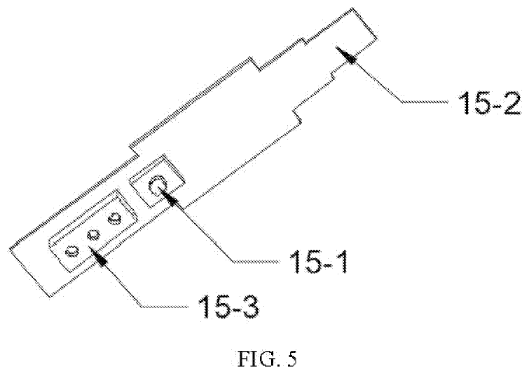

Referring to FIG. 1 to FIG. 5, in the embodiments of the present disclosure, an intelligent stylus with a battery level indicator includes a stylus tail cap, a stylus body and a stylus tip. The stylus body includes an aluminum holder shell 1 and a holder internal component; the stylus tail cap is arranged at the tail portion of the aluminum holder shell 1; the aluminum holder shell 1 is arranged at a large portion of the stylus body and is mainly used to protect and hide the holder internal component; the holder internal component includes a switch charging component, an LED battery level indicator component, internal connection components and a ground clip 21 which mainly constitute a stylus body internal main body; the switch charging component is arranged at the front portion of the stylus tail cap; the LED battery level indicator component is arranged at the front portion of the switch charging component; the internal connection components are arranged on both sides of a battery 11 inside the stylus body; and the stylus tip is arranged at a head portion of the stylus body.

The stylus tail cap is composed of a screw 17, a cylindrical magnet 18 with screw hole, a stylus tail cap aluminum piece 19 and a stylus tail cap plastic piece 20; the screw 17 is in female threaded connection with the stylus tail cap plastic piece 20 through the cylindrical magnet 18, and passes through the stylus tail cap aluminum piece 19 to form the stylus tail cap, which is mainly used to protect internal substances of the stylus from being exposed from the stylus tail.

The switch charging component is composed of a switch plate plastic positioning piece 14, a switch and indicator printed circuit board (PCB) 15 and a magnetic attraction iron piece 16. The switch plate plastic positioning piece 14 is provided with a plastic button hole 14-1 and a plurality of LED light-transmittance holes 14-2, and is aligned with a power button 15-1 and a charging port 15-2 on the switch and indicator PCB 15. The LED light-transmittance holes 14-2 are used to meet a requirement for light transmittance for battery level displaying. Four or five lamps can be used, or a display screen can be used for digital displaying. A Microusb charging port slot 16-1 is formed in the magnetic attraction iron piece 16. The Microusb charging port slot 16-1 can also adopt a typec port slot. The charging port 15-2 and the Microusb charging port slot 16-1 form a charging port. It is a type-c port when the charging port is located on a side edge; and it is a micro-usb when the charging port is located inside the tail cap. The charging port can be placed on the side edge of the tail portion of the stylus body, or placed at the tail portion of the stylus body and covered with the tail cap. The switch charging component is mainly used to control a power supply of the stylus.

The LED battery level indicator component is formed by combining the switch plate plastic positioning piece 14 and the switch and indicator PCB 15. The switch plate plastic positioning piece 14 is provided with the plurality of LED light-transmittance holes 14-2 that are adhered to LED light-shield isolation pillars 15-3 on the switch and indicator PCB 15. The LED battery level indicator component is mainly used to display a battery level of the intelligent stylus.

The internal connection components are composed of two flexible printed circuit (FPC) flat cable connectors 22, and magnet and magnet connection components 23; the two FPC flat cable connectors 22 include an FPC flat cable connector A 22-1 and an FPC flat cable connector B 22-2; and the magnet and magnet connection components 23 include a magnet and magnet connection component A 23-1 and a magnet and magnet connection component B 23-2. The FPC flat cable connector A 22-1 is mainly used to connect the switch charging component, the LED battery level indicator component and the magnet and magnet connection component A 23-1; the magnet connection component A 23-1 is mainly used to connect the FPC flat cable connector A 22-1 with the battery 11; the magnet and magnet connection component B 23-2 is mainly used to connect the battery 11, the FPC flat cable connector B 22-2 and the ground clip 21; and the internal connection components mainly play a role of connecting the internal components.

The ground clip 21 is disposed at the front portion of the FPC flat cable connector B 22-2 and used to connect the FPC flat cable connector B 22-2, and mainly plays a role of assisting in shielding signal interference and modulating oscillation signals and the like.

The stylus tip is composed of a plastic stylus tip cap 2, a stylus needle 5, an aluminum oxidization tube 6, a threaded copper piece 7, an aluminum tube pressing piece 8 and a main PCB 9. There are three electrical connection lines in total. The first electrical connection line is mainly used to weld the stylus needle 5 on the PCB 9; the second electrical connection line presses the aluminum oxidization tube 6 with the aluminum tube pressing piece 8; the aluminum oxidization tube 6 is a cylindrical hard oxidization piece, the inner and outer walls of which are provided with insulators. Therefore, the three electrical connection lines are separated. The plastic stylus tip cap 2 and the threaded copper piece 7 are in threaded connection with each other.

The ground clip 21 is connected with a metal ground antenna 4 through the main PCB 9; the head portion of the main PCB 9 is disposed on the aluminum holder shell 1 through a plastic positioning pillar 3; a magnet A 10 is mounted on a side of the main PCB 9 corresponding to a flat part of the aluminum holder shell 1 through an insulation sheet; and a magnet B 13 is also mounted in a flat groove of a magnetic body plastic positioning piece 12 located inside the aluminum holder shell 1.

The above is only the preferred embodiments of the present disclosure, and is not intended to limit the present disclosure. Any modifications, equivalent replacements and improvements that are made within the spirit and principle of the present disclosure shall fall within the protection scope of the present disclosure.

What is claimed is:

1. An intelligent stylus with a battery level indicator, comprising a stylus tail cap, a stylus body and a stylus tip, wherein the stylus body comprises an aluminum holder shell (1) and a holder internal component; the stylus tail cap is arranged at the tail portion of the aluminum holder shell (1); the aluminum holder shell (1) is arranged at a large portion of the stylus body; the holder internal component comprises a switch charging component, an LED battery level indicator component, internal connection components and a ground clip (21); the switch charging component is arranged at the front portion of the stylus tail cap; the LED battery level indicator component is arranged at the front portion of the switch charging component; the internal connection components are arranged on both sides of a battery inside the stylus body, and the stylus tip is arranged at a head portion of the stylus body.

2. The intelligent stylus with the battery level indicator according to claim 1, wherein the stylus tail cap is composed of a screw (17), a cylindrical magnet (18) with screw hole, a stylus tail cap aluminum piece (19) and a stylus tail cap plastic piece (20); the screw (17) is in female threaded connection with the stylus tail cap plastic piece (20) through the cylindrical magnet (18), and passes through the stylus tail cap aluminum piece (19) to form the stylus tail cap.

3. The intelligent stylus with the battery level indicator according to claim 1, wherein the switch charging component is composed of a switch plate plastic positioning piece (14), a switch and indicator printed circuit board (PCB) (15) and a magnetic attraction iron piece (16); the switch plate plastic positioning piece (14) is provided with a plastic button hole (14-1) and a plurality of LED light-transmittance holes (14-2), and is aligned with a power button (15-1) and a charging port (15-2) on the switch and indicator PCB (15); a Microusb charging port slot (16-1) is formed in the magnetic attraction iron piece (16); and the charging port (15-2) and the Microusb charging port slot (16-1) form a charging port.

4. The intelligent stylus with the battery level indicator according to claim 3, wherein the LED battery level indicator component is formed by combining the switch plate plastic positioning piece (14) and the switch and indicator PCB (15); and the switch plate plastic positioning piece (14) is provided with the plurality of LED light-transmittance holes (14-2) that are adhered to LED light-shield isolation pillars (15-3) on the switch and indicator PCB (15).

5. The intelligent stylus with the battery level indicator according to claim 1, wherein the internal connection components are composed of two flexible printed circuit (FPC) flat cable connectors (22), and magnet and magnet connection components (23); the two FPC flat cable connectors (22) comprise an FPC flat cable connector A (22-1) and an FPC flat cable connector B (22-2); and the magnet and magnet connection components (23) comprise a magnet and magnet connection component A (23-1) and a magnet and magnet connection component B (23-2).

6. The intelligent stylus with the battery level indicator according to claim 5, wherein the ground clip (21) is arranged at the front portion of the FPC flat cable connector B (22-2).

7. The intelligent stylus with the battery level indicator according to claim 1, wherein the stylus tip is composed of a plastic stylus tip cap (2), a stylus needle (5), an aluminum oxidization tube (6), a threaded copper piece (7), an aluminum tube pressing piece (8) and a main PCB (9).

8. The intelligent stylus with the battery level indicator according to claim 7, wherein the aluminum oxidization tube (6) is a cylindrical hard oxidization piece, the inner and outer walls of which are provided with insulators.

9. The intelligent stylus with the battery level indicator according to claim 7, wherein the plastic stylus tip cap (2) and the threaded copper piece (7) are in threaded connection with each other.

10. The intelligent stylus with the battery level indicator according to claim 1, wherein the ground clip (21) is connected with a metal ground antenna (4) through the main PCB (9); the head portion of the main PCB (9) is disposed on the aluminum holder shell (1) through a plastic positioning pillar (3); a magnet A (10) is mounted on a side of the main PCB (9) corresponding to a flat part of the aluminum holder shell (1) through an insulation sheet; and a magnet B (13) is also mounted in a flat groove of a magnetic body plastic positioning piece (12) located inside the aluminum holder shell (1).
